(19) United States
(12) Patent Application Publication
(10) Pub. No.: US 2015/0226265 A1
(43) Pub. Date: Aug. 13, 2015

(54) SYSTEMS, APPARATUSES AND METHODS FOR LIFTING, POSITIONING AND REMOVING A BEARING ASSEMBLY FROM A SHAFT

(71) Applicant: Weir Slurry Group, Inc., Madison, WI (US)

(72) Inventors: Ron J. Bourgeois, Sun Prairie, WI (US); Randy J. Kosmicki, Edgerton, WI (US); Michael L. Viken, Cottage Grove, WI (US)

(21) Appl. No.: 14/616,472

(22) Filed: Feb. 6, 2015

Related U.S. Application Data
(60) Provisional application No. 61/937,229, filed on Feb. 7, 2014.

(51) Int. Cl. F16C 35/06; B66C 1/62; F16C 35/04

(52) U.S. Cl. CPC F16C 35/062; F16C 35/042; B66C 1/62; F16C 35/06; F16C 2237/00

(57) ABSTRACT

Apparatuses include an upper body and a lower body coupleable to the upper body for forming a channel to support a bearing assembly therein. A retention member extends into the channel from at least one of the upper body or the lower body. The retention member is configured to engage the bearing assembly to secure the bearing assembly within the channel. The apparatus further includes a lifting member formed in the upper body for receiving a hoisting member for lifting the bearing assembly.

### CROSS-REFERENCE TO RELATED APPLICATION

This application claims priority to U.S. Provisional Patent Application No. 61/937,229 filed Feb. 7, 2014, which is incorporated herein by reference in its entirety.

### TECHNICAL FIELD

This disclosure relates to bearing assemblies, and, in particular, to systems, apparatuses and methods for lifting, positioning and removing a bearing assembly from a shaft.

### BACKGROUND OF THE DISCLOSURE

Bearings are used to reduce friction between and support moving parts, such as, for example, rotating shafts. Bearings have a finite operating life, requiring periodic replacement and routine maintenance to prevent failure. Several factors impact the service life of a bearing or the frequency for required maintenance. For example, bearing loads, operating temperature, exposure to external environments, contamination, lubrication and even electrical currents acting on the bearing may impact a bearing's service life or the frequency that maintenance must be conducted.

Oftentimes it is difficult to replace or service bearings due to the location, size, weight, method of coupling or type of bearing. A bearing, for example, may weigh several hundred pounds and/or be coupled to a part or shaft through an interference fit. As a result, it is oftentimes necessary to remove the rotor or shaft assembly in its entirety to replace or repair the bearings. In some instances, the entire machine must be transported to a maintenance facility to replace the bearings. However, it is desirable to replace bearings without (i) requiring removal of the rotor assembly or rotor shaft and/or (ii) transporting the machine to a maintenance facility.

### SUMMARY

In a first aspect, there is provided an apparatus for lifting and/or otherwise supporting a bearing assembly. The apparatus includes an upper body and a lower body coupleable to the upper body for forming a channel to support the bearing assembly therein. A retention member extends into the channel from at least one of the upper body or the lower body. The retention member is configured to engage the bearing assembly to secure the bearing assembly within the channel. The apparatus further includes a lifting member formed in the upper body for receiving a hoisting member for lifting the bearing assembly.

In certain embodiments, the retention member comprises a lip configured to engage a groove on the bearing assembly.

In other embodiments, the retention member extends into the channel from the upper body and the lower body.

In yet another embodiment, the lower body includes at least one leg extending from the lower body.

In still another embodiment, the apparatus further comprises at least one leg extending from the lower body, the at least one leg having a foot extending from a distal end of the first leg to support the apparatus on a support surface and prevent the bearing assembly from contacting the support surface while lifting.

In certain embodiments, the upper and lower bodies are arcuate.

In other embodiments, the upper and lower bodies each include a pair of flanges for securing the upper and lower bodies together.

In yet another embodiment, the apparatus further comprises at least one aligning member disposed on at least one of the upper or lower bodies, the at least one aligning member movable to radially position the bearing assembly relative to the upper and lower bodies.

In still another embodiment, the at least one aligning member is threadably secured to the at least one of the upper and lower bodies.

In certain embodiments, the at least one aligning member includes a tip for engaging the bearing assembly, the tip formed of a low-friction material.

In other embodiments, the at least one aligning member extends radially into the channel to radially position the bearing assembly relative to the upper and lower bodies.

In yet another embodiment, the lifting member includes a connection member to receive the hoisting member, wherein the connection member is substantially aligned with a center of gravity of the bearing assembly when the bearing assembly is supported by the apparatus.

In still another embodiment, the upper body is hinged to the lower body.

In certain embodiments, the weight of the bearing assembly is supported by the upper and lower bodies when the bearing assembly is positioned on or removed from a shaft.

In a second aspect, an apparatus for supporting a bearing assembly with a hoist includes an upper body and a lower body such that the lower body is configured to be attached to the upper body to form a channel to support the bearing assembly. The upper body has an inner wall, an opposing outer wall, a front face, and an opposing back face. The lower body has an inner wall and an opposing outer wall. A retention member extends from and along at least a portion of the inner wall of at least one of the upper body or the lower body. The retention member is configured to engage the bearing assembly. The apparatus further includes a hanger assembly attached to and extending from the outer wall of the upper body such that the hanger assembly is cantilevered beyond the back face of the upper body and configured to be secured to the hoist.

In certain embodiments, the retention member extends from the inner wall along a circumference of the inner wall and the retention member is configured to fit within a groove formed in the bearing assembly.

In other embodiments, the hanger assembly is secured to the outer wall. The hanger assembly includes a first body and a second body, the first body extends from the upper body and the second body is cantilevered from the first body and extends beyond the back face of the upper body. The second body includes an attachment mechanism for receiving the hoist.

In yet another embodiment, the second body is cantilevered a distance from the first body such that the attachment mechanism is substantially aligned with a center of gravity of the bearing assembly when the bearing assembly is supported by the apparatus.

In still another embodiment, the upper and lower bodies are arcuately shaped to encompass the bearing assembly.

In certain embodiments, the apparatus further comprises a leg extending from the outer wall of the lower body to support the apparatus on a support surface and prevent the bearing assembly from contacting the surface while lifting.

In other embodiments, the leg further comprises a foot extending from a distal end of the leg.

In yet another embodiment, the upper and lower bodies each include a pair of diametrically opposed flanges such that the upper body flanges are configured to align with the lower body flanges to secure the upper and lower bodies together.

In a third aspect, a lifting tool for aligning a bearing assembly with a shaft includes a body configured to surround at least a portion of the bearing assembly. The body has one or more aligning members movable to position the bearing assembly relative to the body to align the bearing assembly with the shaft.

In certain embodiments, the lifting tool further comprises at least one retention member.

In certain embodiments, the lifting tool further comprises at least one retention member, and wherein the at least one retention member comprises one or more protrusions extending therefrom to engage and secure the bearing assembly to the body.

In other embodiments, the body comprises an upper body and a lower body, the upper and lower bodies forming a channel to receive the bearing assembly therein.

In yet another embodiment, the lifting tool further comprises a hanger assembly attached to the body, the hanger assembly configured to receive a hoisting member.

In still another embodiment, the hanger assembly includes an alignment mechanism operable to adjust the position of the bearing assembly relative to the shaft.

In certain embodiments, the bearing assembly is lifted by a hoisting member through the bearing assembly's center of gravity.

In a fourth embodiment, a method for positioning at least a portion of a bearing assembly on a shaft includes the steps of securing a lifting tool at least partially around the bearing assembly; and aligning the lifting tool with a longitudinal axis of the shaft The method further comprises the steps of adjusting the radial position of the bearing assembly relative to the longitudinal axis of the shaft using a set of aligning members; positioning the bearing assembly onto the shaft; and removing the lifting tool from the bearing assembly.

In an illustrative embodiment, the method includes adjusting the angular position of the lifting tool relative to the longitudinal axis of the shaft using a set of aligning members.

In certain embodiments, the method further includes the steps of attaching a lifting tool to a hoist assembly; and positioning the lifting tool adjacent the shaft using the hoist assembly.

In other embodiments, positioning the lifting tool comprises elevating the lifting tool through the bearing assembly's center of gravity.

In yet another embodiment, elevating the lifting tool through the bearing assembly's center of gravity comprises elevating the lifting tool when a longitudinal axis of the bearing assembly is generally horizontal.

In a fifth aspect, a method for positioning at least a portion of a bearing assembly on a shaft includes the steps of securing a lifting tool at least partially around the bearing assembly; aligning the lifting tool with a longitudinal axis of the shaft; and adjusting the angular position of the lifting tool relative to the longitudinal axis of the shaft using a set of aligning members. The method further includes positioning the bearing assembly onto the shaft and removing the lifting tool from the bearing assembly.

In certain embodiments, the method includes the step of adjusting the radial position of the bearing assembly relative to the longitudinal axis of the shaft using a set of aligning members.

In a sixth aspect, an apparatus for removing a bearing assembly from a rotor shaft includes a base member, a drive member extending through the base member to contact an end of a rotor shaft and an extension member connected to the base member at a first end of the extension member, and coupleable to the bearing assembly at a second and opposite end of the extension member. The drive member, when actuated, moves the base member and thus the extension member, to exert a pulling force on the bearing assembly to move the bearing assembly along the rotor shaft for removal thereof.

In certain embodiments, the removal apparatus further comprises a fastener engaging the drive member proximate a face of the base member.

In other embodiments, the drive member is a bolt and the fastener is a nut, and wherein the bolt threadingly engages the nut.

In yet another embodiment, the fastener is welded to the back face of the base member.

In still another embodiment, the drive member extends through a center portion of the base plate.

In certain embodiments, the removal apparatus further comprises a plurality of extension members extending from the base member.

In other embodiments, the extension member is configured to attach to a bearing sleeve.

In yet another embodiment, the extension member is configured to attach to a spacer positioned adjacent to an inner race of the bearing assembly.

In still another embodiment, the extension member is configured to attach to a spacer, and wherein the bearing assembly is positioned between the spacer and the base member.

In certain embodiments, the removal apparatus further comprises an extender member coupleable to the extension member.

In other embodiments, the extender member includes a first end and an opposing second end, wherein the first end threadingly engages the extension member and the second end threadingly engages a bearing assembly.

In yet another embodiment, the removal apparatus further comprises two or more handles positioned on an outer periphery of the base member.

In still another embodiment, the base member is a circular plate.

In a seventh aspect, a method for removing a bearing assembly from a shaft includes the steps of attaching a first end of at least one rod to the bearing assembly and a second opposed end to a base member. The method further includes the steps of positioning a drive member through the base member; aligning the base member such that the drive member contacts an end portion of the shaft; and moving the drive member to push against the shaft to cause the base member to move and, thus, the bearing assembly to move along a longitudinal axis of the shaft to facilitate removal of the bearing assembly from the shaft.

In certain embodiments, the method further comprises the step of attaching a fastener to the drive member proximate a back face of the base member.

In other embodiments, the method further comprises securing the fastener to prevent rotation thereof in response to movement of the drive member.

In yet another embodiment, moving the drive member comprises rotating the drive member to cause movement of the base member and, thus, movement of the bearing assembly along the longitudinal axis of the shaft to facilitate removal thereof.

In an eighth aspect, a method for removing a bearing assembly from a shaft includes the steps of securing a first end of at least one rod to a spacer positioned adjacent the bearing assembly; positioning a drive member through a base member; and positioning a distal end of the drive member against an end of the shaft. The method further includes the steps of securing a second end of the at least one rod to the base member; and actuating the drive member thereby causing the base member to move and, thus, the bearing assembly to travel along a longitudinal axis the shaft to facilitate removal of the bearing assembly from the shaft.

In a ninth aspect, there is provided a method for removing a bearing assembly from a shaft. The method includes securing a first end of at least one rod to a spacer positioned adjacent the bearing assembly, positioning a drive member through a base member and positioning a distal end of the drive member against an end of the shaft. The method also includes securing a second end of the at least one rod to the base member actuating the drive member thereby causing the base member to move, and thus, the bearing assembly to travel along a longitudinal axis the shaft, to facilitate removal of the bearing assembly from the shaft.

In a tenth aspect, there is provided a bearing assembly having a bearing puller sleeve and at least an inner race of a bearing. The bearing puller sleeve is for use with a removal apparatus having an extension member for removing a bearing assembly from a shaft. The bearing puller sleeve includes an annular wall configured for positioning at least partially around the shaft and a front wall configured to be positioned adjacent the inner race of the bearing. The sleeve has one or more apertures formed therein for receiving the extension member from the removal apparatus. The sleeve is also configured such that the front wall, when pulled by the extension member, exerts a force on the inner race to move the inner race along the shaft for removal thereof.

In an eleventh aspect, there is provided a bearing assembly for use with a removal apparatus having an extension member for removing the bearing assembly from a shaft. The bearing assembly includes a carrier sleeve having one or more apertures formed therein for receiving the extension member, the carrier sleeve configured to be positioned on the shaft. A bearing is mounted to the carrier sleeve such that at least a portion of the carrier sleeve is disposed between the bearing and the shaft. The carrier sleeve, when pulled by the extension member, causes the bearing to move along the shaft for removal thereof.

According to a twelfth aspect, there is provided a puller sleeve for use with a bearing removal apparatus for removing at least a portion of a bearing assembly from a rotating shaft. The puller sleeve configured for positioning at least partially around the shaft and coupleable to the removal apparatus such that in response to actuation of the removal apparatus, the sleeve is positioned to exert pulling force to move the bearing assembly along the shaft for removal thereof.

Other aspects, features, and advantages will become apparent from the following detailed description when taken in conjunction with the accompanying drawings, which are a part of this disclosure and which illustrate, by way of example, principles of the inventions disclosed.

### DESCRIPTION OF THE FIGURES

The accompanying drawings facilitate an understanding of the various embodiments.

FIG. 1 is a cross-sectional view of a close-coupled pump according to an exemplary embodiment, the close-coupled pump having a power end and a fluid end.

FIG. 1A is a cross-sectional view of the power end of FIG. 1 illustrating a rotor shaft having a dry end bearing assembly and a wet end bearing assembly positioned thereon.

FIG. 2 is an isometric view of a lifting tool according to an exemplary embodiment for lifting, positioning and removing a bearing assembly.

FIG. 3 is a front view of the lifting tool illustrated in FIG. 2.

FIG. 4 is a cross-sectional view of the lifting tool illustrated in FIG. 3 taken along the line 4-4 of FIG. 3.

FIG. 5 is a top view of the lifting tool illustrated in FIG. 3.

FIG. 6 is an isometric view of a bearing assembly removal apparatus according to an exemplary embodiment.

FIG. 7 is a front view of a base member according to the bearing assembly removal apparatus illustrated in FIG. 6.

FIG. 8 is a cross-sectional view of the base member illustrated in FIG. 7 taken along the line 8-8 of FIG. 7.

FIG. 9 is a bearing assembly according to an exemplary embodiment.

FIG. 10 is a cross-sectional view of the bearing assembly illustrated in FIG. 9.

FIG. 11 is an isometric view of the lifting tool of FIGS. 2-5, according to an exemplary embodiment, connected to a hoisting hook prior to being assembled around a bearing assembly attached to a rotor shaft.

FIG. 12 is an isometric, cross-sectional view of a lifting tool and a bearing assembly removal apparatus, according to an exemplary embodiment, the lifting tool being attached to a hoisting hook.

FIG. 13 is an isometric, partial cross sectional-view, of a wet end bearing assembly positioned on a rotor shaft according to an exemplary embodiment.

FIG. 14 is an isometric cross-sectional view of a bearing assembly removal apparatus according to an exemplary embodiment, attached to a bearing assembly with the bearing assembly in a first position.

FIG. 15 is an isometric cross-sectional view of the bearing assembly removal apparatus illustrated in FIG. 14, attached to a bearing assembly with the bearing assembly in a second position.

### DETAILED DESCRIPTION

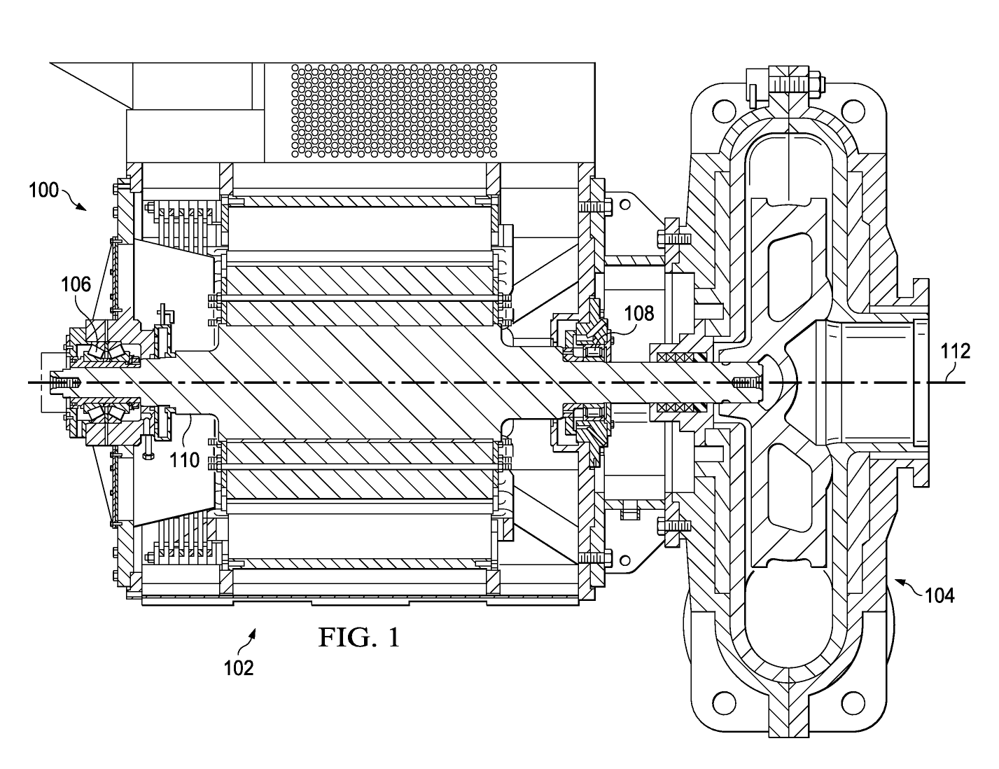

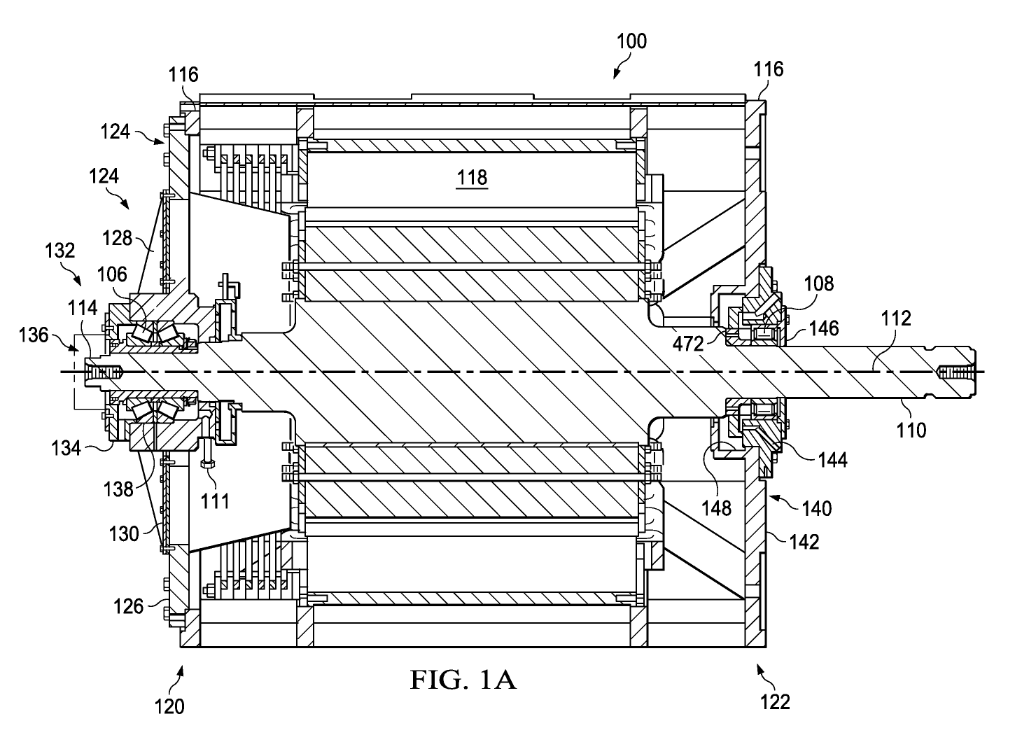

Referring to FIG. 1, an embodiment of a close-coupled pump 100 employing a power end 102, a fluid end 104 and a rotor shaft 110 extending between the power end 102 and the fluid end 104 is illustrated. The power end 102 has a first bearing assembly 106, oftentimes referred to as a dry end bearing assembly, and a second bearing assembly 108, oftentimes referred to as a wet end bearing assembly. Each of the bearing assemblies can also be referred to as sub-assemblies. The dry end bearing assembly 106 and the wet end bearing assembly 108 are both mounted on the rotor shaft 110, which rotates about a longitudinal axis 112. The close-coupled pump 100 is an illustrative, non-limiting example of how one or more bearing assemblies may be utilized and is not meant to infer a specific number or type of bearing assembly. While one skilled in the art will appreciate that bearings may be utilized in a number of different applications, the close-coupled pump 100 will be used as a backdrop for illustrating systems, methods and apparatuses for lifting, positioning and removing bearings from a rotor shaft, such as the rotor shaft 110, without removing the rotor shaft 110 from the close-coupled pump 100.

In an illustrative embodiment, the fluid end 104 of the close-coupled pump 100 is a rotodynamic centrifugal type pump. In another illustrative embodiment, the close-coupled pump 100 is a rotodynamic pitot tube type pump. In an illustrative embodiment, the power end 102 is an electric motor. In a non-limiting embodiment, the electric motor is an induction motor or a switched reluctance motor. In another non-limiting embodiment, the power end 102 is a diesel motor. It should be appreciated that the power end 102 may be replaced by a bearing assembly designed to support the shaft 110 at the wet end and coupled to a separate power source.

Referring to FIG. 1A, an exemplary embodiment of the power end 102 is shown in more detail. The power end 102 includes a motor housing 116 having a stator 118 and the shaft 110 substantially positioned therein. The stator 118 is fixed to the motor housing 116 in a manner that limits rotation of the stator 118 relative to the motor housing 116. The shaft 110 is rotatably coupled to the motor housing 116 and rotates relative to the stator 118. The dry end bearing assembly 106 and the wet end bearing assembly 108 are mounted to the shaft 110 at opposite ends of the motor housing 116 such that the dry end bearing assembly 106 is positioned proximate a closed end 120 of the motor housing 116, and the wet end bearing assembly 108 is positioned proximate a drive end 122 of the motor housing 116.

In the embodiment illustrated in FIG. 1A, a closed end plate assembly 124 is disposed on the closed end 120 and includes an end plate 126, a closed end bracket 128, motor chamber access plates 130 and a bearing assembly cover 132. The motor chamber access plates 130 are removably attached to the closed end bracket 128 such that, when removed, access is provided to the shaft 110 adjacent the closed end 120 of the motor housing 116. The bearing assembly cover 132 includes a bearing access plate 134 and an end cap 136. The bearing access plate 134 is removably affixed to the closed end bracket 128 with at least one fastener, and the end cap 136 is removably affixed to the bearing access plate 134. Removal of the bearing assembly cover 132 exposes the dry end bearing assembly 106 and bearing support surfaces 138 that securely house the dry end bearing assembly 106 to the motor housing 116.

With continued reference to FIG. 1A, a drive end plate assembly 140 is disposed on the drive end 122 and includes an end plate 142, a bearing housing 144 and a bearing assembly cover 146, which is removably affixed to the bearing housing 144 to provide access to the wet end bearing assembly 108.

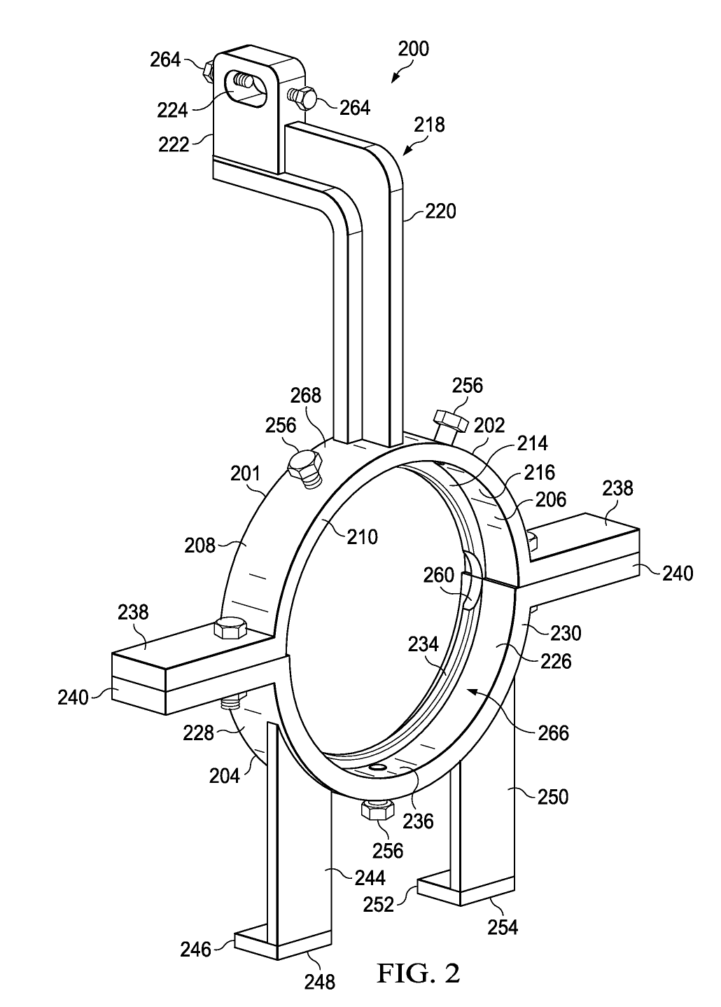

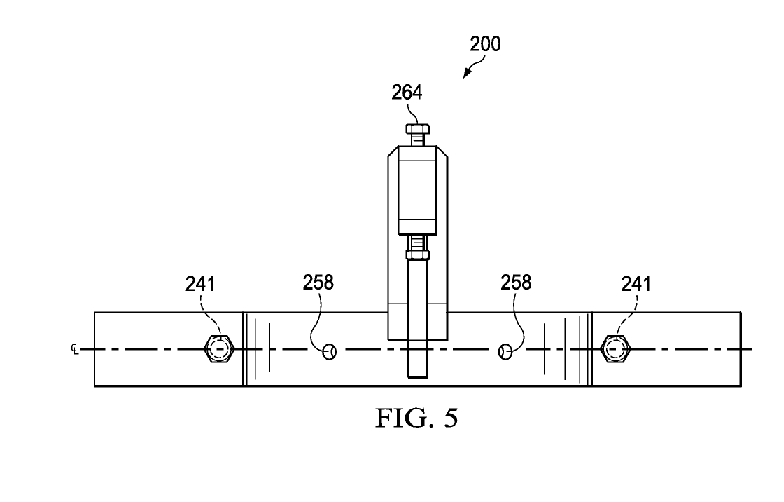

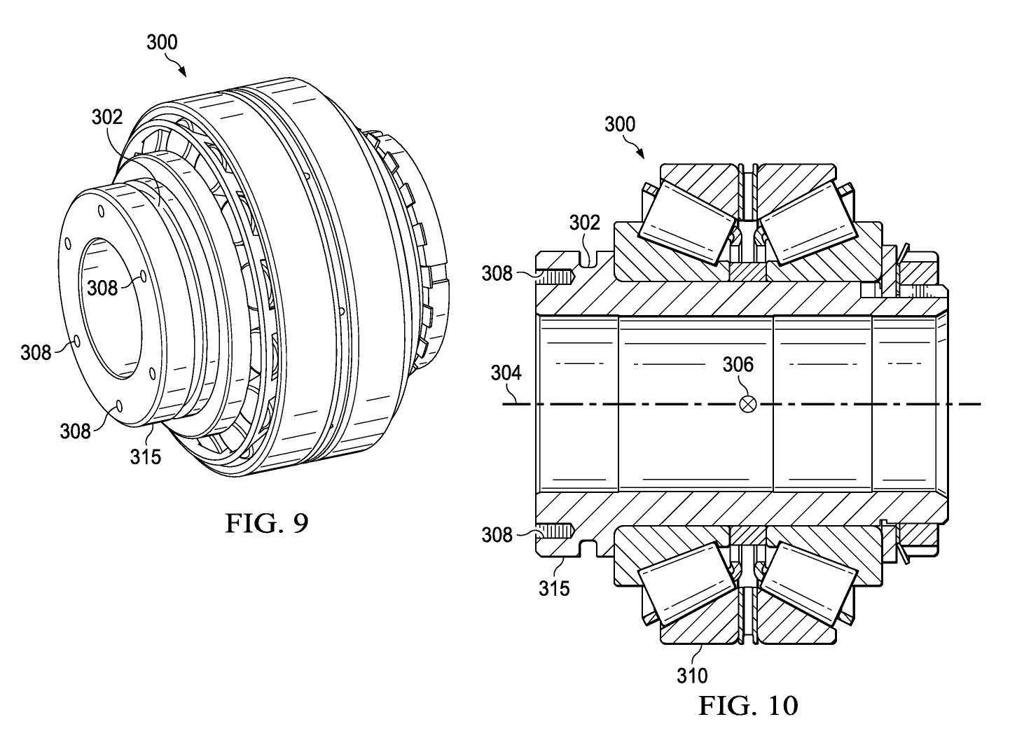

Referring now to FIGS. 2-5, with additional reference to FIGS. 9-11, a lifting apparatus or lifting tool 200 for hoisting a bearing assembly 300 is illustrated. In the embodiment illustrated in FIGS. 9-11, the bearing assembly 300 is a dry end bearing assembly similar to the bearing assembly 106; however, it should be understood that the bearing assembly 300 may in other embodiments be a wet end bearing assembly 108. In the embodiment illustrated in FIGS. 9-10, the bearing assembly 300 includes a tapered roller bearing 310 mounted to a carrier sleeve 315 that is secured to the shaft 110; however, in some embodiments, the carrier sleeve may be omitted from the assembly 300 and the roller bearing 310 secured to the shaft 110 by other means. In use, the lifting tool 200 is used to position the bearing assembly 300 (i.e., the tapered roller bearing 310 and the carrier sleeve 315) on a rotor shaft, such as the rotor shaft 110 illustrated in FIG. 1. In particular, the bearing assembly 300 is placed onto the rotor shaft 110, removed from the rotor shaft 110 or repositioned on the rotor shaft 110 using the lifting tool 200.

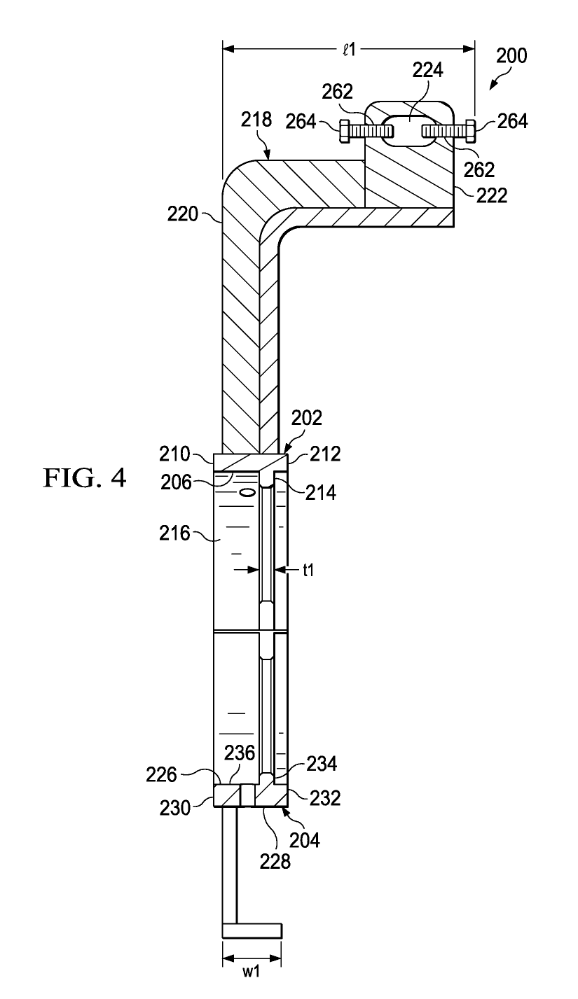

Referring specifically to FIGS. 2-5, the lifting apparatus or lifting tool 200 includes an upper body 202 and a lower body 204 having a predetermined width, w1 (FIG. 4). The upper body 202 if formed having an inner wall 206, an opposing outer wall 208, a front face 210, and an opposing back face 212. In the embodiment illustrated in FIGS. 2-5, the upper body 202 includes a retention member 214, such as, for example, a lip or one or more protrusions, extending radially from at least a portion of the inner wall 206 to, as discussed in greater detail below, secure the bearing assembly 300 to the lifting tool 200. In the illustrated embodiment, the upper body 202 is arcuate or semi-annular in shape with an inner wall circumference 216. According to some embodiments, the retention member 214 extends from the inner wall 206 and substantially along the entire circumference 216; however, in other embodiments, the retention member extends only partially along the circumference 216.

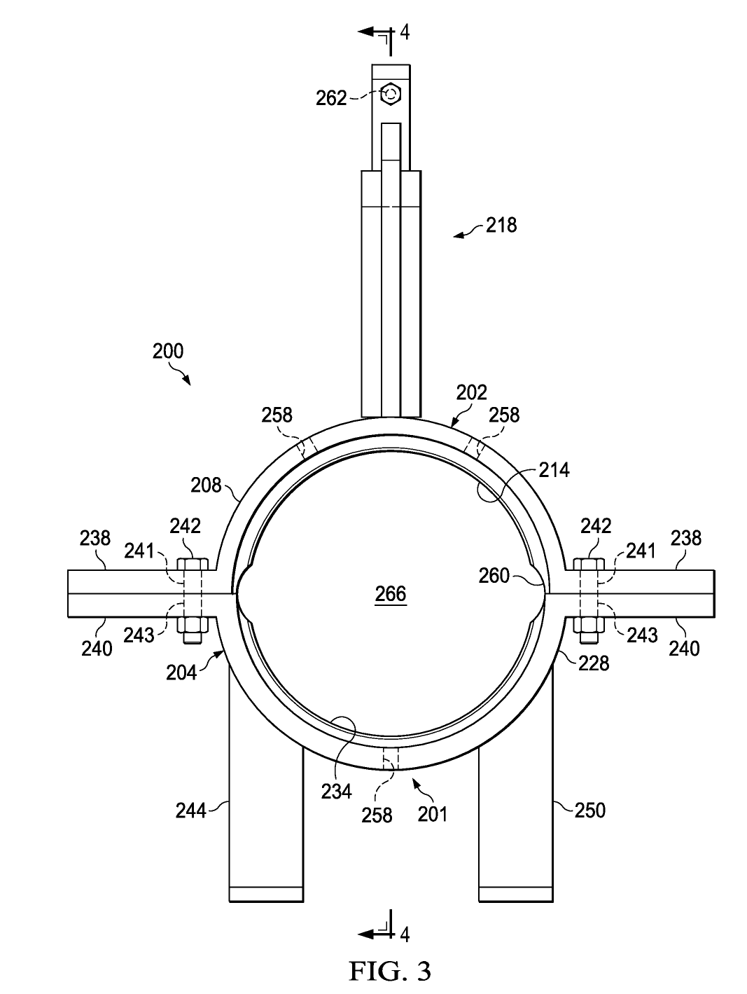

Similarly, the lower body 204 of the lifting tool 200 is formed having an inner wall 226, an opposing outer wall 228, a front face 230 and an opposing back face 232. According to some embodiments, the lower body 204 includes a retention member 234 extending from the inner wall 226, and in some embodiments, is dimensionally identical and aligned with the retention member 214 on the upper body 202. As illustrated in FIG. 3, the lower body 204 is arcuate or semi-annular in shape with an inner wall circumference 236. As illustrated in FIGS. 2 and 3, the retention member 234 extends from the inner wall 226 along the circumference 236 and is configured secure the bearing assembly 300 to the lifting tool 200. In other embodiments, the retention member 234 extends only partially along the circumference 236. As illustrated in FIG. 2, the lower body 204 is configured to be attached to the upper body 202 and forms a ring 201 for clamping around and supporting the bearing assembly 300. Described another way, the upper and lower bodies 202 and 204 form a channel 266 when assembled for receiving and supporting the bearing assembly 300 therein.

In use, the retention members 214 and 234 are configured to engage the bearing assembly 300 and otherwise secure the bearing assembly 300 within the channel 266. In an embodiment, the retention members 214 and 234 extend into the channel 266 from the upper and lower bodies 202 and 204 and are configured to engage or fit within a corresponding groove 302 to secure the bearing assembly 300 relative to the lifting tool 200 when the lifting tool 200 has been assembled around, and encompasses, the bearing assembly 300. It should be understood that in lieu of incorporating both retention members 214 and 234, the lifting tool 200 may utilize only retention member 214 or retention member 234. In use, the weight of the bearing assembly 300 is supported by the lifting tool 200 when the bearing assembly 200 is positioned on or removed from the shaft 110.

According to an embodiment disclosed herein, the lifting tool 200 is made from steel and the retention members 214 and 234 have a thickness, t1 (FIG. 4), of approximately 10 mm. In one non-limiting embodiment, the retention members 214 and 234 have a thickness, t1, of between 20% (percent) and 80% of the width, w1, and the retention members 214 and 234 extend a length, d1, of approximately 3 mm. In one non-limiting embodiment, the retention members 214 and 234 have a length, d1, of between 50% and 120% of the thickness, t1. In other embodiments, the retention members 214 and 234 may be offset from a center line, C1, of the upper body 202. In another embodiment, the retention members 214 and 234 are offset from the center line, C1, such that the retention members 214 and 234 is closer to the back face 212 than the front face 210 of the upper body 202. In additional embodiments, the retention members 214 and 234 are positioned between 0% and 50% the width, w1, of the upper body 202 from the back face 212 of the upper body 202.

Referring still to FIGS. 2-5, and with additional reference to FIGS. 9-11, an upper set of diametrically opposed flanges 238 extend from the upper body 202 and a lower set of diametrically opposed flanges 240 extend from the lower body 204. The lower set of diametrically opposed flanges 240 are configured to align with and attach to the upper set of diametrically opposed flanges 238. In the illustrated embodiment, a set of apertures 241 in the upper set of flanges 238 align with a set of apertures 243 in the lower set of flanges 240 (FIG. 3) along a centerline C1. Fasteners 242 are positioned through the apertures 241 and 243 to attach and secure the lower set of flanges 240 to the upper set of flanges 238. When assembled, the upper body 202 and lower body 204 form a relief section 260 that, when assembled, reduce stress concentrations where the inner wall 206 of the upper body 202 meets the inner wall 226 of the lower body 204. In other embodiments, the upper body 202 is hinged to the lower body 204 (not shown).

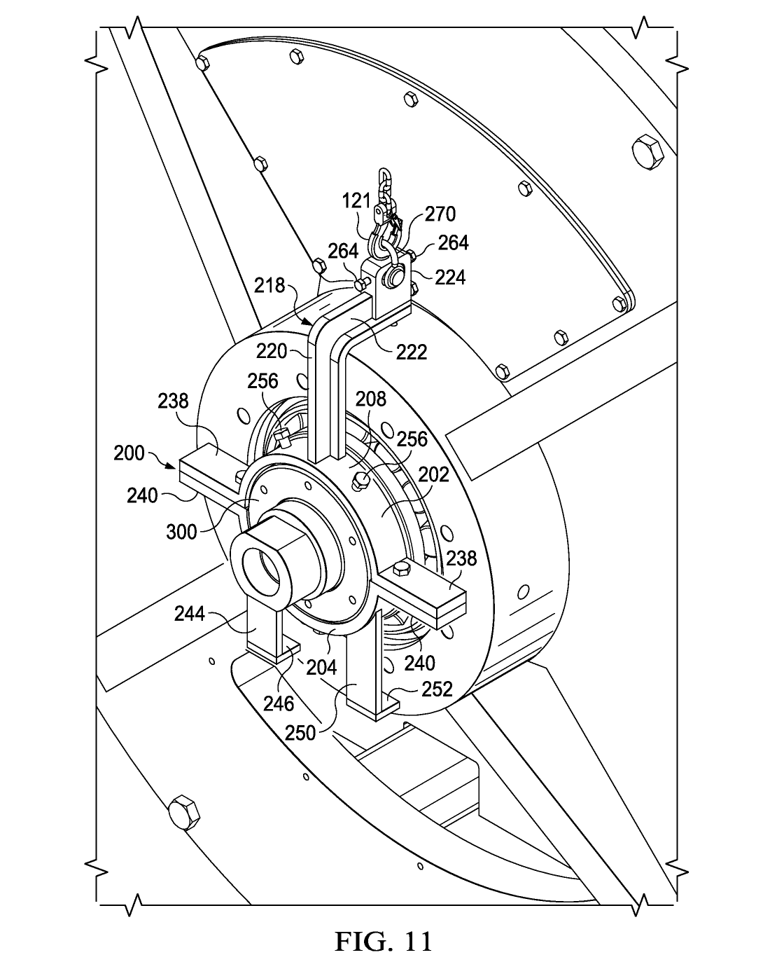

As illustrated in FIGS. 2-5, a lifting member or a hanger assembly 218 is formed in the upper body 202 and is configured to provide a means for lifting the lifting tool 200. The hanger assembly 218 further includes a connection member or an attachment mechanism 224, which includes an opening formed through the hanger assembly 218. In one embodiment, a clevis pin 270 (FIG. 11) is positioned through the opening.

In the embodiment illustrated in FIGS. 2-5, the hanger assembly 218 extends outward from the outer wall 208 of the upper body 202. In particular, the hanger assembly 218 extends from the outer wall 208 at a top portion 268 of the upper body 202 and is cantilevered beyond the back face 212 of the upper body 202 (FIG. 4). In the embodiment illustrated in FIGS. 2-5, the hanger assembly 218 and the upper body 202 are formed as a single unitary piece through casting, molding or other similar methods of manufacturing. In another embodiment, the hanger assembly 218 is attached or connected to the upper body 202 by welding or other known means of attaching two parts together.

In an illustrative embodiment, the hanger assembly 218 includes a first body 220 and a second body 222 whereby the second body 222 is cantilevered from the first body 220 and extends beyond or otherwise past the back face 212 of the upper body 202. In one embodiment, the second body 222 includes the connection member 224, which includes an opening formed within the second body 222.

Referring specifically to FIG. 4, the second body 222 is cantilevered a length, 11, from the first body 220 such that a portion of the second body 222 is substantially aligned with a center of gravity 306 of the bearing assembly 300. According to embodiments disclosed herein, the opening in the connection member 224 of the second body 222 is substantially aligned with the center of gravity 306 when the longitudinal axis 304 of the bearing assembly 300 is in a horizontal position. In yet another embodiment, the opening in the connection member 224 is formed in the second body 222 such that the opening is substantially aligned with the center of gravity 306 when the longitudinal axis 304 of the bearing assembly 300 is substantially aligned with the longitudinal axis 112 of the rotor shaft 106.

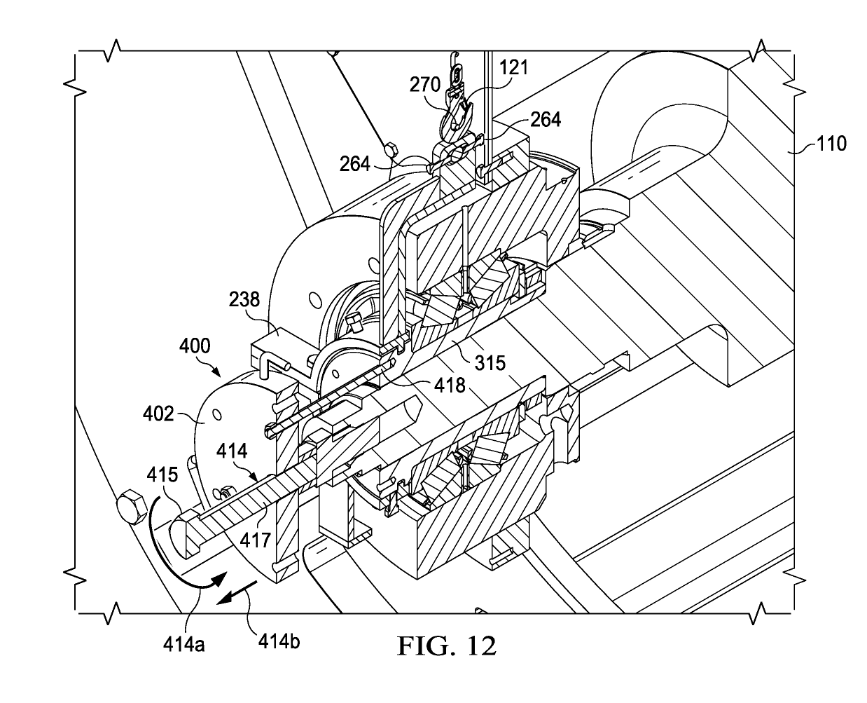

The hanger assembly 218 is configured to receive a hoisting member 121 (shown in FIGS. 11-12). In an embodiment, the hoisting member 121 may be a hook, clasp, retention member, or other type of fastener or gripping device for attaching to the lifting member or hanger assembly 218. In an embodiment, the opening in the connection member 224 of the hanger assembly 218 is substantially aligned with the center of gravity 306 of the bearing assembly 300 when the bearing assembly 300 is supported by the hoisting member 121.

According to embodiments disclosed herein, at least one aperture 262 is formed in the second body 222 and extends therethrough. The at least one aperture 262 is formed to access the opening in the connection member 224 and is configured to receive an aligning member or mechanism 264 to adjust the position of the lifting tool 200 and the bearing assembly 300 into a substantially horizontal position or coaxial, as discussed hereinafter, with the shaft 110. A level may be used to determine when the bearing assembly 300, along its longitudinal axis 304, is substantially horizontal.

According to some embodiments, the aligning member 264 is a jacking bolt or a jacking screw and further, there may be more than one aligning member 264 depending on the number of apertures 262. The one or more aligning members 264 are operable to be positioned between an engaging/extended position, in which the aligning members are inserted or otherwise extend within the opening of the connection member 224, and a retracted position, in which the aligning members 264 are at least partially retracted from the opening. In one embodiment, the one or more aligning members 264 are threadably secured to the apertures 262 and each optionally include a tip formed of a low-friction material, such as, for example, nylon, brass or any other low friction material.

In operation, adjusting the aligning member 264 changes the position or angular alignment of the lifting tool 200 so that the lifting force runs through the center of gravity 306 of the bearing 300 when the longitudinal axis 304 of the bearing is substantially horizontal. In one embodiment, the clevis pin 270 is positioned through the opening in the connection member 224 in the hanger assembly 218. The one or more aligning members 264 are positioned in the engaging/extended position to act against the clevis pin 270 in order to control the angular alignment of the lifting tool 200 until the longitudinal axis 304 of the bearing assembly 300 is substantially horizontal. Generally, the bearing's center of gravity 306 will be on the longitudinal axis 304 of the bearing assembly 300. Adjusting the angular alignment of the lifting tool 200 adjusts the position or direction of the lifting force.

In some embodiments, a first leg 244 extends from the outer wall 228 of the lower body 204 with a foot 246 optionally extending from a distal end 248 of the first leg 244. A second leg 250 extends from the outer wall 228 of the lower body 204 with a foot 252 optionally extending from a distal end 254 of the second leg 250. The first and second legs 244 and 250 help guide the bearing assembly 300 as it is being lifted off of a surface other than the rotor shaft 110 (e.g. a work surface) and prevents contact of the bearing assembly 300 to the surface while lifting.

Referring specifically to FIG. 2, one or more aligning members 256 are positioned through corresponding apertures 258 formed in the upper and lower bodies 202 and 204 and extend radially into the channel 266. The one or more aligning members 256 are configured to adjust a position of the bearing assembly 300 relative to the lifting tool 200 after the lifting tool 200 has been positioned on or around the bearing assembly 300. The one or more aligning members 256 provide refined radial adjustments of the bearing assembly 300 relative to the upper and lower bodies 202 and 204. According to an embodiment disclosed herein, the aligning members 256 are jacking bolts or screws and are operable to be positioned between an engaging position and a retracted position. In one embodiment, the one or more aligning members 256 are threadably secured to the apertures 258. According to some embodiments, the aligning member 256 includes a tip for engaging the bearing assembly 300 formed of a low-friction material, such as, for example nylon, brass or any other low friction material. In operation, the one or more aligning members 256 are operable to work in concert to adjust a radial position of the bearing assembly 300 relative to the lifting tool 200 after the apparatus 200 has been fastened to the bearing assembly 300 for alignment with the shaft 110. In one embodiment, the one or more aligning members 256 project radially relative to the bearing assembly 300. As illustrated, for example, in FIGS. 2 and 3, the one or more apertures 258 and the one or more aligning members 256 are angularly spaced apart on the upper and lower bodies 202 and 204 forming an angle of about thirty degrees to about ninety degrees therebetween. In an exemplary, non-limiting embodiment, the each of the one or more apertures 258 forms an angle of 45 degrees therebetween.

According to embodiments disclosed herein, a hoist system known in the art may be used to elevate a lifting tool 200 and generally align the bearing assembly 300 with the rotor shaft 110. The fitting tolerances between the bearing assembly 300 and the rotor shaft 110 may result in a clearance between the bearing assembly 300 and the rotor shaft 110 on the order of 1/1000^{th} of an inch. Thus, once the bearing assembly 300 has been generally aligned with the rotor shaft 110, the one or more aligning members 256 are operable, as previously discussed, to be used to make fine adjustments to the bearing assembly 300 position relative to the lifting tool 200 and, correspondingly, to the rotor shaft 110.

In operation, the lifting tool or assembly 200 is assembled around the bearing assembly 300. The hoist assembly is attached to the lifting tool 200 and provides enough force to the lifting tool 200 to support the weight of both the lifting tool 200 and the bearing assembly 300. The aligning members 264 extending through the aperture 262 in the second body 222 are operable to adjust the clevis pin 270 or the hoisting member 121 so that the lifting tool 200 is movable relative to the hoisting member 121 to align the hoisting member 121 with the center of gravity 306 of the bearing assembly 300 in the event the hoisting member is not already aligned with the center of gravity 306. The aligning members 256 are adjusted (i.e., extended into and removed from the channel 266) to radially align the bearing assembly 300 with the rotor shaft 110. The bearing assembly 300 is then positioned onto the shaft 110 or removed from the shaft 110.

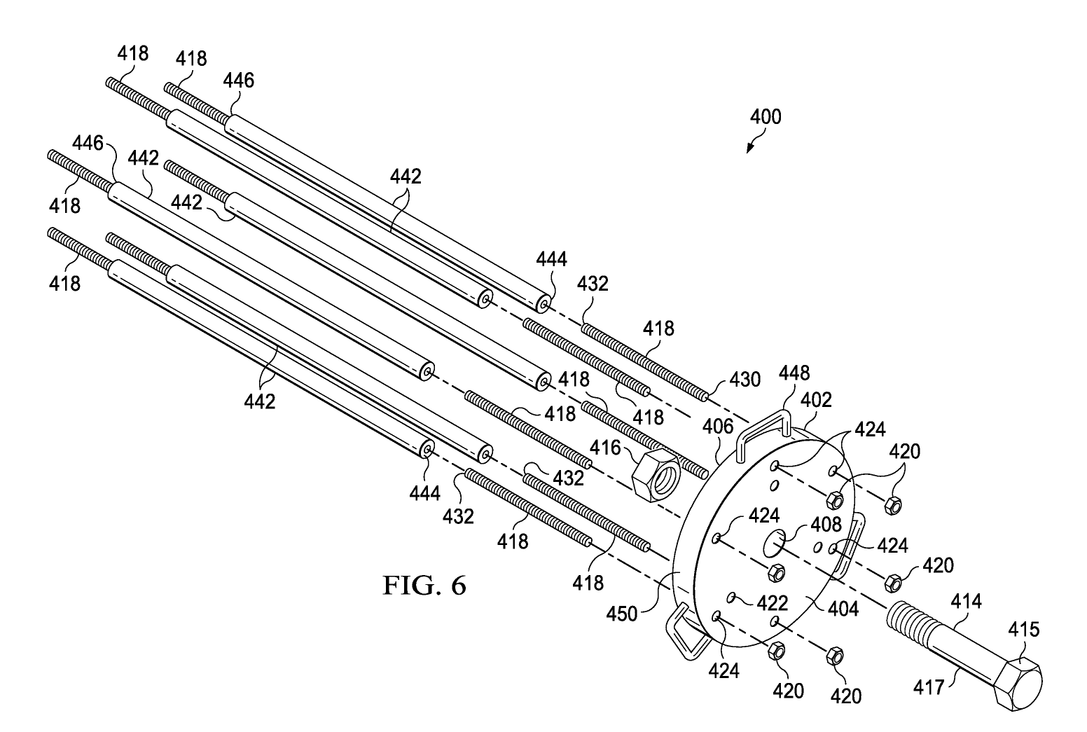

Referring now to FIGS. 6-8, with additional reference to FIGS. 9-10 and 12-15, a bearing assembly removal apparatus 400 is illustrated for removing the bearing assembly 300 from the rotor shaft 110 without removing the rotor assembly and shaft 110 from the pump 100. For example, the removal apparatus 400 is configured to remove the wet end bearing assembly 108 and the dry end bearing assembly 106 from the rotor shaft 110 without removing the rotor assembly and the shaft 110 from the power end 102.

In the embodiment illustrated in FIGS. 6-8, the removal apparatus 400 includes a base member or plate 402 having a front face 404 and a back face 406, a drive member/jacking bolt 414, and one or more pulling rods/extension members 418 extending from the base member 402 to, as discussed in further detail below, engage and/or otherwise interface with the bearing assembly 300 for removal thereof.

In the embodiment illustrated in FIGS. 6-8, the base member 402 includes a circular cross section; however, the base member 402 may be otherwise shaped. For example, the base member 402 may include a square shaped cross section and/or otherwise be shaped as a hub and spoke type arrangement. According to some embodiments, the base member 402 is formed of steel and has a thickness, t1, of approximately 38 mm, although the thickness varies depending on the expected force required to remove the bearing assembly 300 from the shaft 110. According to embodiments disclosed herein, the base member 402 is formed having a diameter, D3, of approximately 280 mm, although the diameter is dependent on the size of the bearing assembly 300.

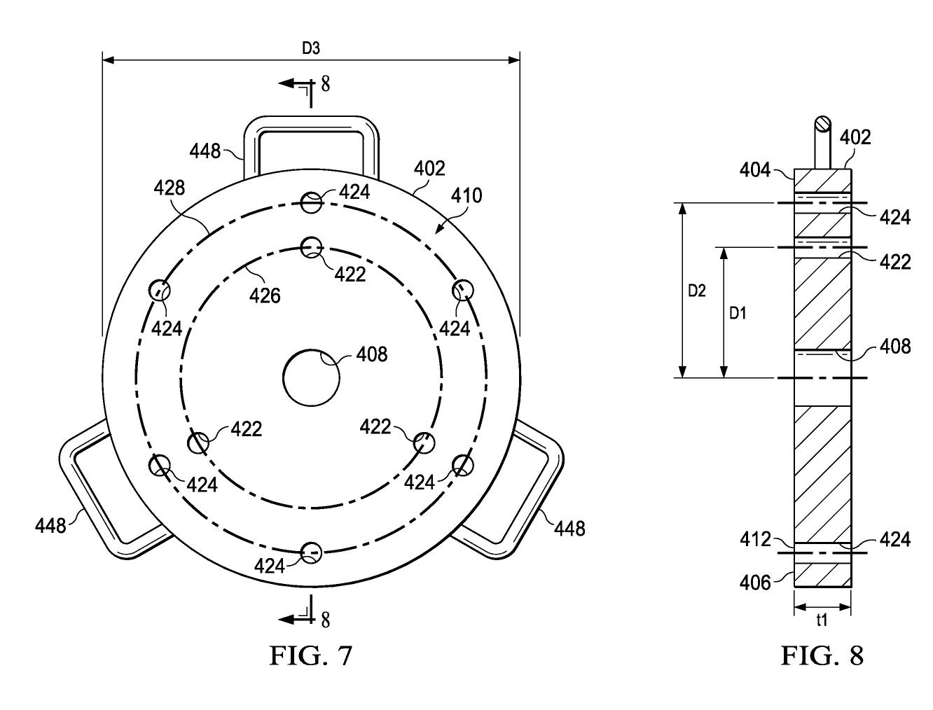

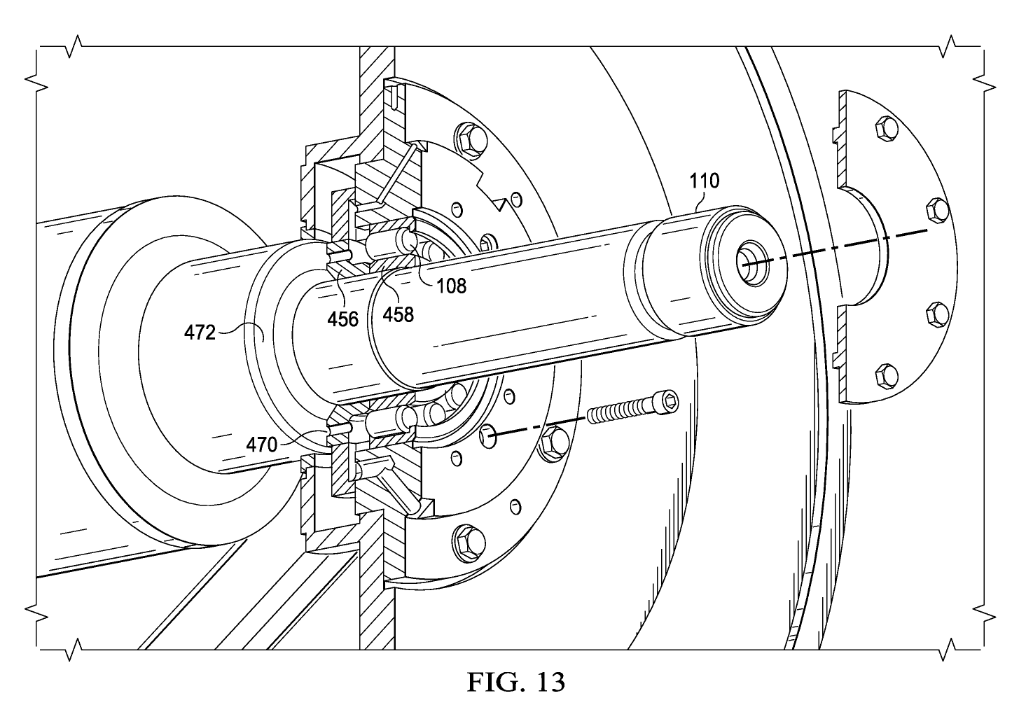

The base member 402 includes a central opening/hole 408 extending therethrough sized to receive the drive member 414 and inner and outer peripheral openings/holes 422 and 424, respectively, that extend through the base member 402. Referring specifically to FIGS. 6 and 7, inner peripheral openings 422 are disposed a first radial distance D1 from the central opening 408 and the outer peripheral openings 424 are formed at a second radial distance, D2, from the central opening 408. As illustrated in the embodiment in FIG. 8, the second distance, D2, is greater than the first distance D1, and both distances D1 and D2 are selected so as to facilitate alignment of the openings 422 and 424 with corresponding tapped holes/apertures 308 disposed in the bearing assembly 300 (FIGS. 9 and 10) and tapped holes/apertures 470 in a bearing pulling sleeve or spacer member 456 (FIGS. 13-15), respectively. As discussed in greater detail below, the alignment of openings 422 and 424 with tapped holes 308 and 470 enable the base member 402 to be coupled and otherwise secured to the bearing assemblies 106 and 108 via the extension members/rods 418 to facilitate removal of the bearing assemblies 106 and 108 from the rotating shaft 110. In the embodiment illustrated in FIGS. 6-8, three inner peripheral openings 422 are positioned at radially spaced apart positions around the central opening 408, although a greater or fewer numbers of inner peripheral openings 422 may be utilized. Similarly, in the embodiment illustrated in FIGS. 6-8, six outer peripheral openings 424 are radially spaced around the central opening 408. Referring particularly in FIG. 7, the first set of peripheral openings 422 are formed along a first circular path 426 and the second set of peripheral openings 424 are formed along a second and outer circular path 428; however, it should be understood that the position of inner and outer peripheral openings 422 and 424 can vary, and further, that the shape of paths 426 and 428 may also vary.

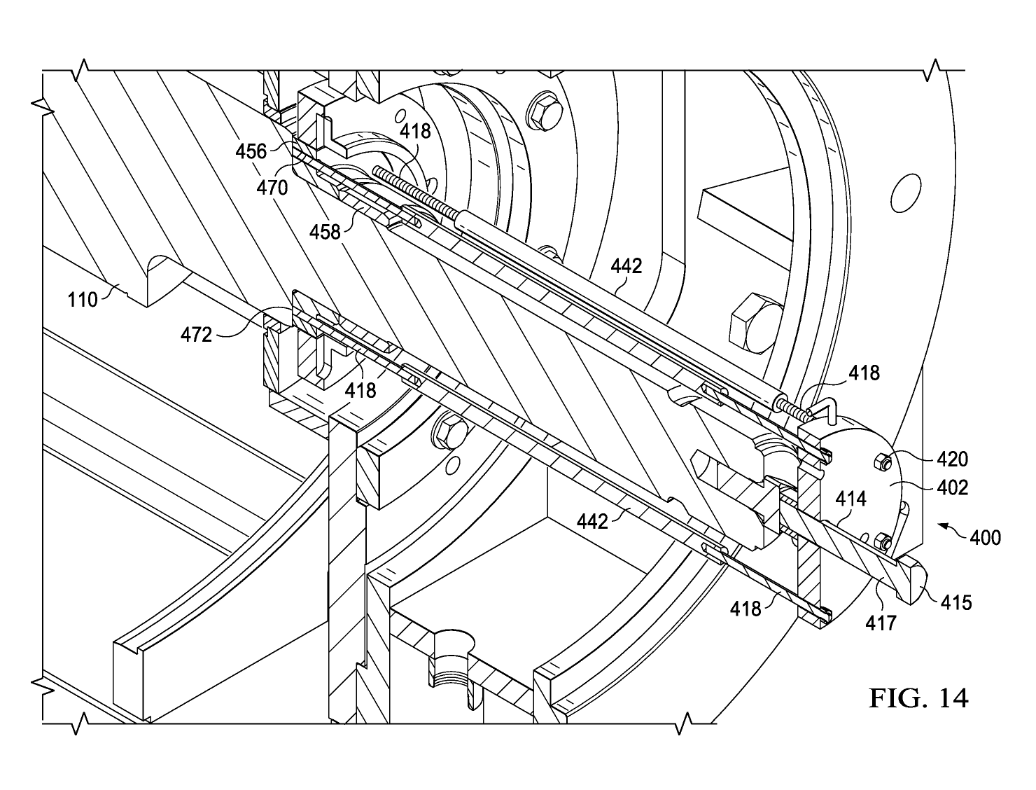

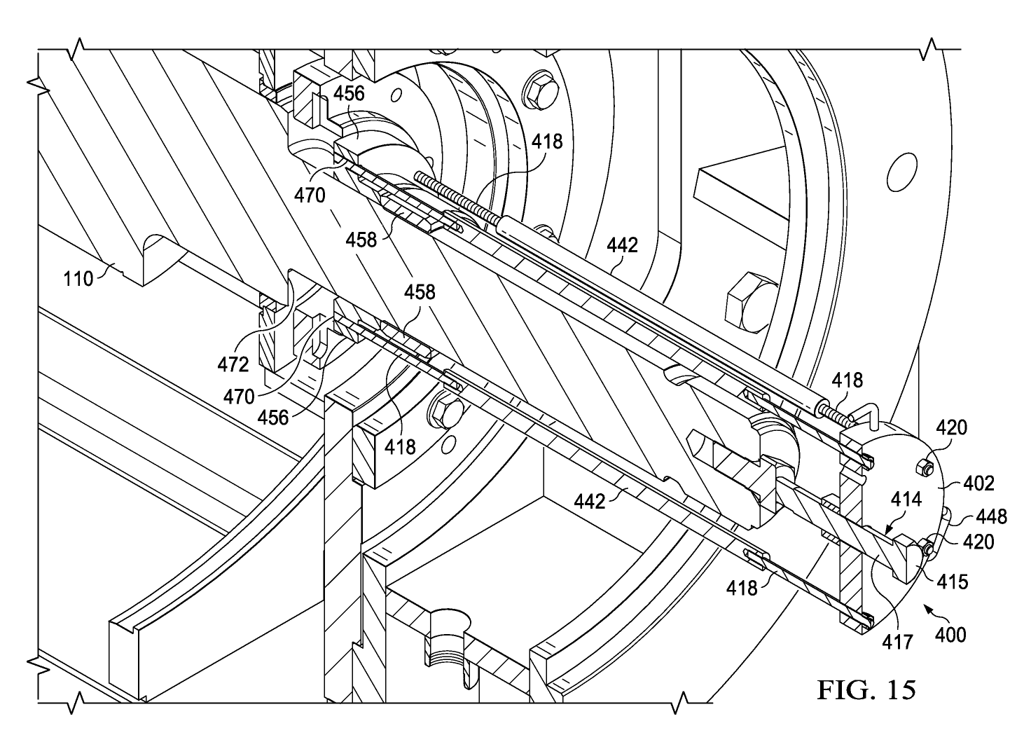

As illustrated in FIGS. 6 and 12, each extension member 418 is coupled to the base member 402 such that it extends outwardly from the back face 406. In FIG. 6, each extension member 418 is secured to the base member 402 by a fastener 420, such as a bolt or other attachment means, disposed proximate the front face 404 of the base member 402. In particular, in the embodiment illustrated in FIGS. 6 and 12, the extension member 418 has a threaded first end 430 insertible through openings 422 or 424 and coupleable to the base member 402 via the fastener 420. The extension member 418 further includes and an opposed second end 432 that is coupleable either directly to the bearing assembly 300 via the tapped hole 308 (FIGS. 9 and 10), or coupleable to the spacer 456, which forms a part of the bearing assembly 108, via the tapped hole 470 (FIG. 15), the spacer 456, as discussed in further detail below, being utilized to push and otherwise move the wet end bearing assembly 108 along the shaft 110 to facilitate removal of the bearing assembly 108 from the shaft 110. In lieu of utilizing fasteners 420, each opening 422 and 424 may include a threaded interior (not illustrated) to facilitate engagement with a threaded end 430 of the extensions 418 to secure each extension 418 to the base member 402. In the embodiment illustrated in FIGS. 6 and 12, for example, the second end 432 of each extension member 418 is coupled directly to the bearing assembly 106 or 108. In particular, as illustrated for example in FIG. 12, the second ends 432 of the extension members 418 engage and are otherwise secured in a corresponding tapped hole or aperture 308 of the bearing assembly 300. In the embodiment illustrated, for example, in FIGS. 9 and 10, the tapped holes 308 are formed in the carrier sleeve 315; however, in other embodiments, depending on the type of bearing assembly 300, the tapped holes 308 may be formed directly on the roller bearing 310 for removal thereof. In the embodiment illustrated in FIGS. 14 and 15, for example, the second end 432 of the extension members 418 engage and are otherwise secured to a corresponding tapped hole or aperture 470 in the spacer 456, for, as discussed in further detail below, removal of the wet end bearing assembly 108.

Referring specifically to FIG. 6, the jacking bolt/drive member 414 is a bolt having a head 415 and a stem 417. The stem 417 is threaded through the opening 408 and extends past and/or otherwise beyond the back face 406 of the base member 402 for contact with and/or otherwise abutting engagement with the end of the shaft 110. In some embodiments, a fastener or bolt 416 is secured to and/or otherwise forms a part of the base member 402. Accordingly and as discussed in greater detail below, during rotational movement of the jacking bolt 414 to remove the bearing assembly 300, the fastener 420 provides a region to enable a wrench or other tool to engage therewith so as to prevent rotation of the fastener 420.

During removal of the bearing assembly 106 and/or 108, rotation of the jacking bolt 414, when abutted against the end of the shaft 110, enables the base member 402 to traverse along the jacking bolt 414 to thereby slide or otherwise move the bearing assembly 106 and/or 108 along the shaft 110. More particularly and with reference to FIG. 12, for example, rotation of the jacking bolt 414 in the counterclockwise direction of arrow 414a, causes the base member 402 to travel along the length of the stem 417 in the direction of arrow 414b via the threaded engagement, thereby causing the extension members 418 to also move in the direction of 414b. This movement exerts a pulling force on the bearing assembly 106 to move the bearing assembly 106 along the rotor shaft 110 in the direction of arrow 414b to facilitate eventual removal via the lifting tool 200, as previously described.

According to embodiments disclosed herein, the bearing assembly removal apparatus 400 further includes the rod extender members 442 coupleable to the extension members 418 to effectively lengthen the extension members 418 so as to, for example, facilitate the removal of the wet end bearing assembly 108 (FIGS. 14 and 15). In FIG. 6, for example, the extender member 442 has a first end 444 and an opposing second end 446. In use, the first end 444 is coupled an extension member 418 and the second end 446 is coupled to the bearing assembly 300. In other configurations, the second end 446 is coupled to a tapped hole or aperture 308 formed in the carrier sleeve 315 (FIGS. 9 and 10). In yet another embodiment, the second end 446 is coupled to the spacer 456, and in particular, the aperture or tapped hole 470 formed in the spacer 456 (FIGS. 14 and 15). According to specific configurations, the spacer 456 is positioned on the shaft 112 between a shoulder 472 formed on the shaft 110 an inner race 458 of the bearing assembly 108. In operation, the rod extender members 442 and/or the extension members 418 pull the spacer 456 axially along the shaft 110 and away from the shoulder 472, thereby causing the spacer 456 to move the inner race 458 axially along and toward the end of the shaft 110 to facilitate removal of the inner race 458 (and the spacer 456) from the shaft 110.

According to some embodiments, to facilitate the placement or removal of a bearing assembly 106 from the shaft 110, the weight of the shaft 110 is supported by one or more support members 111 (FIG. 1A) such as, for example, a rotor jack. The support members 111 may be shiftably coupled relative to the motor housing 116 for movement between a retracted position and a rotor-support position, in which the support members 111 support the weight of the shaft 110. In particular, the support members 111 help avoid substantial deflection of the shaft 110 due to the weight of the shaft 110. In one embodiment, the portion of the support members 111 in contact with the shaft 110 is comprised of a low-friction, material to (1) prevent the rotor from rotational slippage and (2) protect the shaft 110 if a user does not retract the support members for activating the shaft 110.

In order to facilitate transport and the ability to manually adjust the position of the removal apparatus 400, the removal apparatus 400 includes one or more gripping surfaces/handles 448 positioned on an outer perimeter 450 of the base member 402.

Embodiments disclosed herein provide a method, apparatus and system for positioning a bearing assembly 300, including dry end bearing assembly 106 and wet end bearing assembly 108 on a shaft 110. The method includes securing a lifting tool 200 at least partially around the bearing assembly 300 and aligning the lifting assembly 200 with a longitudinal axis 112 of the shaft 110. The method further includes adjusting the angular position of the lifting tool 200 relative to the longitudinal axis 112 of the shaft 110 using a first set of aligning members 264. The method continues by adjusting the radial position of the bearing assembly 300 relative to the longitudinal axis 112 of the shaft 110 using a second set of aligning members 256, positioning the bearing assembly 300 onto the shaft 110, and removing the lifting tool 200 from the bearing assembly 300.

Embodiments disclosed herein also provide for a method, system and apparatus for removing a bearing assembly 300 from a shaft 110 without removal of the rotor assembly or shaft 110 from a drive end of a pump. The method includes attaching a first end 432 of at least one rod or extension 418 to the bearing assembly 300 and a second opposed end 430 to a base member 402 and positioning a drive member or jacking bolt 414 through the base member 402. The method further includes aligning the base member 402 such that the jacking bolt 414 abuts an end portion of the shaft 110 and moving the jacking bolt 414 when abutting the shaft 110, to cause the base member 402 to move, and thus, to cause the bearing assembly 300 to move along a longitudinal axis 112 of the shaft to facilitate removal of the bearing assembly 300 from the shaft 110.

The systems, apparatuses and methods described herein facilitate replacement and servicing of the bearing assembly 300 since the shaft 110 does not need to be removed from the pump or motor. Advantageously, the bearing assembly 300 can be serviced in the field with the systems, apparatuses, methods described herein and may not require transporting the motor or pump to a maintenance facility.

The systems, apparatuses and methods described herein further facilitate lifting, removing and servicing of antifriction bearings that are secured to a rotating shaft without removing the shaft 110 from the pump or motor. Advantageously, the antifriction bearings can be serviced in the field with the systems, apparatuses, methods described herein without requiring transport of the motor or pump to a maintenance facility.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms such as “clockwise” and “counterclockwise”, “left” and right”, “front” and “rear”, “above” and “below” and the like are used as words of convenience to provide reference points and are not to be construed as limiting terms.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

In addition, the foregoing describes only some embodiments of the invention(s), and alterations, modifications, additions and/or changes can be made thereto without departing from the scope and spirit of the disclosed embodiments, the embodiments being illustrative and not restrictive.

Furthermore, invention(s) have been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s). Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

What is claimed is:

1. An apparatus for lifting a bearing assembly, the apparatus comprising:
an upper body and a lower body coupleable to the upper body, the upper and lower bodies forming a channel to support the bearing assembly therein;
a retention member extending into the channel from at least one of the upper body or the lower body, the retention member configured to engage the bearing assembly to secure the bearing assembly within the channel; and
a lifting member formed in the upper body for receiving a hoisting member for lifting the bearing assembly.

2. The apparatus of claim 1, wherein the retention member comprises a lip configured to engage a groove on the bearing assembly.

3. The apparatus of claim 1, wherein the retention member extends into the channel from the upper body and the lower body.

4. The apparatus of claim 1, wherein the lower body includes at least one leg extending from the lower body.

5. The apparatus of claim 1 further comprising at least one leg extending from the lower body, the at least one leg having a foot extending from a distal end of the first leg to support the apparatus on a support surface and prevent the bearing assembly from contacting the surface while lifting.

6. The apparatus of claim 1, wherein the upper and lower bodies are arcuate.

7. The apparatus of claim 1, wherein the upper and lower bodies each includes a pair of flanges for securing the upper and lower bodies together.

8. The apparatus of claim 1 further comprising at least one aligning member disposed on at the least one of the upper or lower bodies, the at least one aligning member movable to radially position the bearing assembly relative to the upper and lower bodies.

9. The apparatus of claim 8, wherein the at least one aligning member is threadably secured to the at least one of the upper and lower bodies.

10. The apparatus of claim 8, wherein the at least one aligning member includes a tip for engaging the bearing assembly, the tip formed of a low-friction material.

11. The apparatus of claim 8, wherein the at least one aligning member extends radially into the channel to radially position the bearing assembly relative to the upper and lower bodies.

12. The apparatus of claim 1, wherein the lifting member includes a connection member to receive the hoisting member, the connection member is substantially aligned with a center of gravity of the bearing assembly when the bearing assembly is supported by the apparatus.

13. The apparatus of claim 1, wherein the upper body is hinged to the lower body.

14. The apparatus of claim 1, wherein a weight of the bearing assembly is supported by the upper and lower bodies when the bearing assembly is positioned on or removed from a shaft.

15. An apparatus for supporting a bearing assembly with a hoist, the apparatus comprising:
an upper body having an inner wall, an opposing outer wall, a front face, and an opposing back face;
a lower body having an inner wall and an opposing outer wall, the lower body configured to be attached to the upper body to form a channel to support the bearing assembly;
a retention member extending from and along at least a portion of the inner wall of at least one of the upper body or the lower body, the retention member configured to engage the bearing assembly; and
a hanger assembly attached to and extending from the outer wall of the upper body, the hanger assembly cantilevered beyond the back face of the upper body and configured to be secured to the hoist.

16. The apparatus of claim 15, wherein the retention member extends from the inner wall along a circumference of the inner wall, the retention member configured to fit within a groove formed in the bearing assembly.

17. The apparatus of 15, wherein the hanger assembly is secured to the outer wall, the hanger assembly includes a first body and a second body, the first body extends from the upper body and the second body is cantilevered from the first body and extends beyond the back face of the upper body, the second body including an attachment mechanism for receiving the hoist.

18. The apparatus of claim 17, wherein the second body is cantilevered a distance from the first body such that the attachment mechanism is substantially aligned with a center of gravity of the bearing assembly when the bearing assembly is supported by the apparatus.

19. The apparatus of claim 15, wherein the upper and lower bodies are arcuately shaped to encompass the bearing assembly.

20. The apparatus of claim 15 further comprising a leg extending from the outer wall of the lower body to support the apparatus on a support surface and prevent the bearing assembly from contacting the surface while lifting.

21. The apparatus of claim 20, wherein the leg further comprises a foot extending from a distal end of the leg.

22. The apparatus of claim 15, wherein the upper and lower bodies each include a pair of diametrically opposed flanges such that the upper body flanges are configured to align with the lower body flanges to secure the upper and lower bodies together.

23. A lifting tool for aligning a bearing assembly with a shaft, the lifting tool comprising:
a body configured to surround at least a portion of the bearing assembly, the body having one or more aligning members movable to position the bearing assembly relative to the body to align the bearing assembly with the shaft.

24. The lifting tool of claim 23, wherein the lifting tool further comprises at least one retention member.

25. The lifting tool of claim 23, wherein the lifting tool further comprises at least one retention member, and wherein the at least one or more retention member comprises one or more protrusions to engage and secure the bearing assembly to the body.

26. The lifting tool of claim 23, wherein the body comprises an upper body and a lower body, the upper and lower bodies forming a channel to receive the bearing assembly therein.

27. The lifting tool of claim 23 further comprising a hanger assembly attached to the body, the hanger assembly configured to receive a hoisting member.

28. The lifting tool of claim 27, wherein the hanger assembly includes an alignment mechanism operable to adjust the position of the bearing assembly relative to the shaft.

29. The lifting tool of claim 23, wherein the bearing assembly is lifted by a hoisting member through the bearing assembly's center of gravity.

30. A method for positioning a bearing assembly on a shaft, the method comprising:
securing a lifting tool at least partially around the bearing assembly;
aligning the lifting tool with a longitudinal axis of the shaft;
adjusting a radial position of the bearing assembly relative to the longitudinal axis of the shaft using a set of aligning members;
positioning the bearing assembly onto the shaft; and
removing the lifting tool from the bearing assembly.

31. The method of claim 30 further comprising adjusting an angular position of the lifting tool relative to the longitudinal axis of the shaft using a set of aligning members.

32. The method of claim 30 further comprising:
attaching the lifting tool to a hoist assembly; and
positioning the lifting tool adjacent the shaft using the hoist assembly.

33. The method of claim 32, wherein positioning the lifting tool comprises elevating the lifting tool through the bearing assembly's center of gravity.

34. The method of claim 33, wherein elevating the lifting tool through the bearing assembly's center of gravity comprises elevating the lifting tool when a longitudinal axis of the bearing assembly is generally horizontal.

35. A method for positioning a bearing assembly on a shaft, the method comprising:
securing a lifting tool at least partially around the bearing assembly;
aligning the lifting tool with a longitudinal axis of the shaft;
adjusting an angular position of the lifting tool relative to the longitudinal axis of the shaft using a set of aligning members;
positioning the bearing assembly onto the shaft; and
removing the lifting tool from the bearing assembly.

36. The method of claim 35 further comprising adjusting a radial position of the bearing assembly relative to the longitudinal axis of the shaft using a set of aligning members.

37. An apparatus for removing a bearing assembly from a rotor shaft, the apparatus comprising:
a base member;
a drive member extending through the base member to contact an end of the rotor shaft;
an extension member connected to the base member at a first end of the extension member, and coupleable to the bearing assembly at a second and opposite end of the extension member; and
wherein the drive member, when actuated, moves the base member and thus, the extension member, to exert a pulling force on the bearing assembly to move the bearing assembly along the rotor shaft for removal thereof.

38. The removal apparatus of claim 37 further comprising a fastener engaging the drive member proximate a face of the base member.

39. The removal apparatus of claim 38, wherein the drive member is a bolt and the fastener is a nut, and wherein the bolt threadingly engages the nut.

40. The removal apparatus of claim 38, wherein the fastener is welded to the back face of the base member.

41. The removal apparatus of claim 37, wherein the drive member extends through a center portion of the base member.

42. The removal apparatus of claim 37 further comprising a plurality of extension members extending from the base member.

43. The removal apparatus of claim 37, wherein the extension member is configured to attach to a bearing sleeve.

44. The removal apparatus of claim 37, wherein the extension member is configured to attach to a spacer positioned adjacent to an inner race of the bearing assembly.

45. The removal apparatus of claim 44, wherein the extension member is configured to attach to a spacer, and wherein the inner race is positioned between the spacer and the base member.

46. The removal apparatus of claim 37 further comprising an extender member coupleable to the extension member.

47. The removal apparatus of claim 46, wherein the extender member includes a first end and an opposing second end, wherein the first end threadingly engages the extension member and the second end threadingly engages the bearing assembly.

48. The removal apparatus of claim 37 further comprising two or more handles positioned on an outer periphery of the base member.

49. The removal apparatus of claim 37, wherein the base member is a circular plate.

50. A method for removing a bearing assembly from a shaft, the method comprising:
attaching a first end of at least one rod to the bearing assembly and a second opposed end to a base member;
positioning a drive member through the base member and aligning the base member such that the drive member contacts an end portion of the shaft; and
moving the drive member to push against the shaft to cause the base member to move, and thus the bearing assembly to move along a longitudinal axis the shaft to facilitate removal of the bearing assembly from the shaft.

51. The method of claim 50 further comprising attaching a fastener to the drive member proximate a back face of the base member.

52. The method of claim 51 further comprising securing the fastener to prevent rotation thereof in response to movement of the drive member.

53. The method of claim 50, wherein moving the drive member comprises rotating the drive member to cause movement of the base member, and thus movement of the bearing assembly, along the longitudinal axis of the shaft to facilitate removal thereof.

54. A method for removing a bearing assembly from a shaft, the method comprising:
securing a first end of at least one rod to a spacer positioned adjacent the bearing assembly;
positioning a drive member through a base member;
positioning a distal end of the drive member against an end of the shaft;
securing a second end of the at least one rod to the base member; and
actuating the drive member thereby causing thereby causing the base member to move, and, thus, the bearing assembly to travel along a longitudinal axis the shaft, to facilitate removal of the bearing assembly from the shaft.

55. A bearing assembly comprising a bearing puller sleeve and at least an inner race of a bearing, the bearing puller sleeve for use with a removal apparatus having an extension member for removing the bearing assembly from a shaft, the bearing puller sleeve comprising:
an annular wall configured for positioning at least partially around the shaft;
a front wall configured to be positioned adjacent the inner race of the bearing and having one or more apertures formed therein for receiving the extension member from the removal apparatus; and
wherein the front wall, when pulled by the extension member, exerts a force on the inner race to move the inner race along the shaft for removal thereof.

56. A bearing assembly for use with a removal apparatus having an extension member for removing the bearing assembly from a shaft, the bearing assembly comprising:
a carrier sleeve having one or more apertures formed therein for receiving the extension member, the carrier sleeve configured to be positioned on the shaft; and
a bearing mounted to the carrier sleeve such that at least a portion of the carrier sleeve is disposed between the bearing and the shaft;
wherein the carrier sleeve, when pulled by the extension member, causes the bearing to move along the shaft for removal thereof.

57. A puller sleeve for use with a bearing removal apparatus for removing at least a portion of a bearing assembly from a rotating shaft, the puller sleeve configured for positioning at least partially around the shaft and coupleable to the removal apparatus such that in response to actuation of the removal apparatus, the sleeve is positioned to exert pulling force to move the bearing assembly along the shaft for removal thereof.
